(19) United States
(12) Patent Application Publication
(10) Pub. No.: US 2010/0164437 A1
(43) Pub. Date: Jul. 1, 2010

(54) BATTERY FORMATION AND CHARGING SYSTEM AND METHOD

(76) Inventors: Joseph P. McKinley, Brownsburg, IN (US); Stephan A. Sellers, Brownsburg, IN (US); Kent R. Colclazier, Greenfield, IN (US)

Correspondence Address: BOSE MCKINNEY & EVANS LLP, 111 MONUMENT CIRCLE, SUITE 2700, INDIANAPOLIS, IN, 46204, US

(21) Appl. No.: 12/604,234

(22) Filed: Oct. 22, 2009

Related U.S. Application Data
(60) Provisional application No. 61/108,344, filed on Oct. 24, 2008.

(51) Int. Cl. H02J 7/04

(52) U.S. Cl. 320/145; 320/152

(57) ABSTRACT

Method and system for forming or charging batteries or power cells. The system includes control processor; input switch coupled to a power supply, charging switch coupled to the battery, filter network between the input and charging switches, battery temperature sensor, input voltage sensor, and charging voltage and current sensors. The control processor monitors the sensors and controls the switches to deliver a charging waveform to the battery selected to perform an efficient charging of the battery. The method includes applying a charging current pulse, having a current value and a pulse width, to the battery at a repetition rate; monitoring battery temperature; determining whether to change the current value, repetition rate or pulse width; and changing them when determined. Battery resistance can be a determinant. A sensor on a battery post can monitor battery temperature. A hardware temperature sensor can monitor system temperature and be used to detect system resonance.

This application claims priority to U.S. Provisional Patent Application Ser. No. 61/108,344, filed Oct. 24, 2008 entitled “Battery Formation and Charging Controller System,” the disclosure of which is expressly incorporated herein by reference.

### BACKGROUND AND SUMMARY

This invention relates to formation (first charging cycle) as well as charging (subsequent charging cycles) for batteries and power cells, as a means of rapidly charging the batteries or power cells without generating excessive heat, outgassing and electrolyte concentration.

Currently, in applications which require quick battery formation, i.e., the first charging cycle, a high level of current is passed through the battery. This high level of current causes chemical changes to the plate structure, transforming the plates into their final chemical form. During this transformation, heat is generated by the ohmic losses in the conductive material within the battery, by hydrolization (whereby water is broken down into hydrogen and oxygen), and by corrosion (physically removing conductive material from the positive plate and transporting the conductive material to the negative plate area). Rather than lowering the charging current, thereby increasing the required charging time, battery manufacturers have resorted to varying efforts to remove the generated heat, and to compensate for the water and electrolyte losses.

Battery temperature is measured by either a non-invasive technique using a temperature sensor embedded within the charging lead terminals or placement of a sensor in the battery's electrolyte. Since lead is a good heat conductor, the use of a temperature sensor embedded within the terminal method is more reliable than measuring the battery case temperature when access to the electrolyte is not possible, e.g., fully sealed, acid immobilized, or gelled acid batteries.

Embodiments of the present invention comprise a circuit for generating a high current pulse output signal having calculated current and voltage signal characteristics designed to avoid heat generation without increasing the required charge time. Typically the frequency of these pulses is between 100 Hz and 20,000 Hz. Since a battery undergoing charge is undergoing change, any predetermined algorithm is going to be a good fit at only one point in the charge cycle. Thus, embodiments of the present invention are adaptive in nature, matching the electrochemistry latency changes to achieve optimum energy transfer without the undesirable heat generation.

A battery formation and charging process is disclosed for charging a battery using a battery charging system. The battery formation and charging process includes applying a charging current pulse to the battery at a repetition rate, where the charging current pulse has a current value and a pulse width of less than 10 milliseconds. The process also includes monitoring a battery temperature of the battery; determining whether to change at least one of the current value, the repetition rate or the pulse width of the charging current pulse; and changing at least one of the current value, the repetition rate or the pulse width of the charging current pulse, if it is determined that a change is desired.

The battery formation and charging process can also include decreasing the current value of the charging current pulse if the battery temperature exceeds a battery temperature threshold. If the battery includes a battery post; the step of monitoring a battery temperature can include coupling a temperature sensor to the battery post; and monitoring a battery post temperature using the temperature sensor.

The battery formation and charging process can include monitoring a hardware temperature of the battery charging system; and decreasing the repetition rate of the charging current pulse if the hardware temperature exceeds a hardware temperature threshold.

The current value of the charging current pulse can be approximately in the range of 5 to 50 times of a total amp-hour capacity of the battery. The pulse width of the charging current pulse can be approximately in the range of 1 μsec to 7 msec. The repetition rate of the charging current pulse can be approximately in the range of 80 Hertz to 20,000 Hertz.

The battery formation and charging process can also include monitoring a battery voltage across the battery; monitoring a battery current being applied to the battery by the charging current pulse; calculating a battery resistance using the battery voltage and the battery current; and using the battery resistance in the step of determining whether to change at least one of the current value, the repetition rate or the pulse width of the charging current pulse.

The battery formation and charging process can also include selecting the repetition rate for the charging current pulse by sweeping the repetition rate of the charging current pulse across a frequency range; tracking a current transferred to the battery for the frequencies in the frequency range; and making the repetition rate of the charging current pulse have the frequency in the frequency range at which the maximum current is transferred to the battery. The step of selecting the repetition rate can be performed periodically during the battery formation and charging process.

The battery formation and charging process can include determining whether the battery charging system is in resonance; and switching the repetition rate of the charging current pulse if the battery charging system is in resonance. The step of switching the repetition rate of the charging current pulse if the battery charging system is in resonance can include sweeping the repetition rate of the charging current pulse across a frequency range; tracking a current transferred to the battery for the frequencies in the frequency range; and switching the repetition rate of the charging current pulse to the frequency in the frequency range at which the maximum current is transferred to the battery.

The battery formation and charging process can comprise a series of separate steps. Each of the separate steps can include defining the current value of the charging current pulse; defining a maximum repetition rate for the charging current pulse, the repetition rate of the charging current pulse being less than the maximum repetition rate; defining the pulse width of the charging current pulse; defining a maximum battery temperature for the battery; maintaining the battery temperature below the maximum battery temperature; and defining a completion criteria for the step, the step ending when the completion criteria is reached.

One of the separate steps can be a timed step which includes tracking an elapsed time for the timed step. The completion criteria for the timed step can be a total step time, where the timed step ends when the elapsed time reaches the total step time.

One of the separate steps can be a current threshold step which includes tracking an elapsed time for the current threshold step; and tracking applied amp-hours, the applied amp-hours being equal to the amp-hours applied to the battery by the battery charging system. The completion criteria for the current threshold step can be an amp-hours threshold, where the current threshold step ends when the applied amp-hours reaches the amp-hours threshold.

One of the separate steps can be a power threshold step that includes tracking an elapsed time for the power threshold step; and tracking applied watt-hours, the applied watt-hours being equal to the watt-hours applied to the battery by the battery charging system. The completion criteria for the power threshold step can be a watt-hours threshold, where the power threshold step ends when the applied watt-hours reaches the watt-hours threshold.

A battery formation and charging system is disclosed for forming or charging a battery using a power supply. The battery formation and charging system includes a control processor, an input switch, a filter network, a charging switch, a battery temperature sensor, an input voltage sensor, and a charging voltage sensor. The input of the input switch is coupled to the power supply, and the control processor controls the input switch to accept or not accept power from the power supply. The input of the filter network is coupled to the output of the input switch. The input of the charging switch is coupled to the output of the filter network, and the output of the charging switch is coupled to the battery. The control processor controls the charging switch to control the current delivered to the battery. The battery temperature sensor monitors a temperature of the battery, and readings from the battery temperature sensor are monitored by the control processor. The input voltage sensor monitors a voltage applied by the input switch across the filter network, and readings from the input voltage sensor are monitored by the control processor. The charging voltage sensor monitors a voltage applied by the charging switch across the battery, and readings from the charging voltage sensor are monitored by the control processor. The charging current sensor monitors a current controlled by the charging switch and applied to the battery; and readings from the charging current sensor are monitored by the control processor. The control processor uses the readings from the battery temperature sensor, the input voltage sensor, the charging voltage sensor and the charging current sensor to control the input switch and the charging switch to deliver a charging waveform to the battery. The charging waveform is selected to perform an efficient charging of the battery.

The charging switch can be an insulated gate bipolar transistor device. The battery can include a battery post, and the battery temperature sensor can monitor the temperature of the battery post. The charging waveform can have a peak value, a pulse width and a frequency; and the control processor can decrease the peak value of the charging waveform when the control processor determines that the readings from the battery temperature sensor exceed a maximum allowable battery temperature.

The battery formation and charging system can also include a hardware temperature sensor that monitors a temperature of the battery formation and charging system. Readings from the hardware temperature sensor can be monitored by the control processor. The charging waveform can have a peak value, a pulse width and a frequency; and the control processor can use the readings from the hardware temperature sensor to determine whether the battery formation and charging system is in resonance. The control processor can change the frequency of the charging waveform when the control processor determines that the battery formation and charging system is in resonance.

The control processor can control the charging waveform to have one of a fixed pulse width and a varying frequency or a varying pulse width and a fixed frequency; where the control processor controls the varying component to control the current delivered to the battery. The charging waveform can have a frequency; and the control processor can periodically sweep through a range of frequencies to select a desired frequency for the charging waveform, and update the frequency of the charging waveform based on the desired frequency.

The filter network of the battery formation and charging system can include a first capacitor bank, a second capacitor bank and a resistor. The first capacitor bank can include a plurality of capacitors to reduce electrical noise in the power delivered by the output switch. The second capacitor bank can be used to suppress high frequency components in the power delivered by the output switch; where the capacitance values of capacitors in the second capacitor bank are less than the capacitance values of capacitors in the first capacitor bank. The resistor can be used to bleed off voltage from the first and second capacitor banks when power is removed by the input switch.

The charging switch of the battery formation and charging system can include an insulated gate bipolar transistor, a snubber capacitor bank, a resistor, and a hardware temperature sensor. The snubber capacitor bank can be used to suppress high frequency components of current reflections from the battery. The resistor can be used to bleed off voltage from the snubber capacitor bank when power is removed. The hardware temperature sensor can be used to monitor a temperature of the snubber capacitor bank, and readings from the hardware temperature sensor can be monitored by the control processor. The control processor can use the readings from the hardware temperature sensor to determine whether the battery formation and charging system is in resonance; and the control processor can change a frequency of the charging waveform when the control processor determines that the battery formation and charging system is in resonance.

The battery formation and charging system can also include an external monitor, the control processor providing status and data to the external monitor. The control processor can be designed to accept commands from the external monitor.

### BRIEF DESCRIPTION OF DRAWINGS

The above-mentioned and other advantages of the present invention and the manner of obtaining them, will become more apparent and the invention itself will be better understood by reference to the following description of exemplary embodiments of the invention taken in conjunction with the accompanying drawings, wherein:

FIG. 1 illustrates a block diagram of major components of an embodiment of the charging and formation system;

FIG. 2 is a schematic of the major components of an embodiment of the charging and formation system;

FIG. 3 illustrates an input waveform of voltage pulses;

FIG. 4 is a schematic of a battery model;

FIG. 5 is a schematic of the components in accordance with an alternative embodiment of the charging and formation system;

FIGS. 6A and 6B illustrate an embodiment of a control flow diagram for a charging and formation system;

FIG. 7 is a graph of some monitored parameters of a charging and formation system in a fixed frequency, temperature limited profile;

FIG. 8 is a graph of some monitored parameters of a charging and formation system in a fixed pulse width profile;

FIG. 9 is a graph of some monitored parameters and thresholds of a charging and formation system in a variation of a float charge profile; and

FIG. 10 shows the affect of frequency on the efficiency at which a battery accepts a charge.

### DETAILED DESCRIPTION OF EXEMPLARY EMBODIMENTS

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

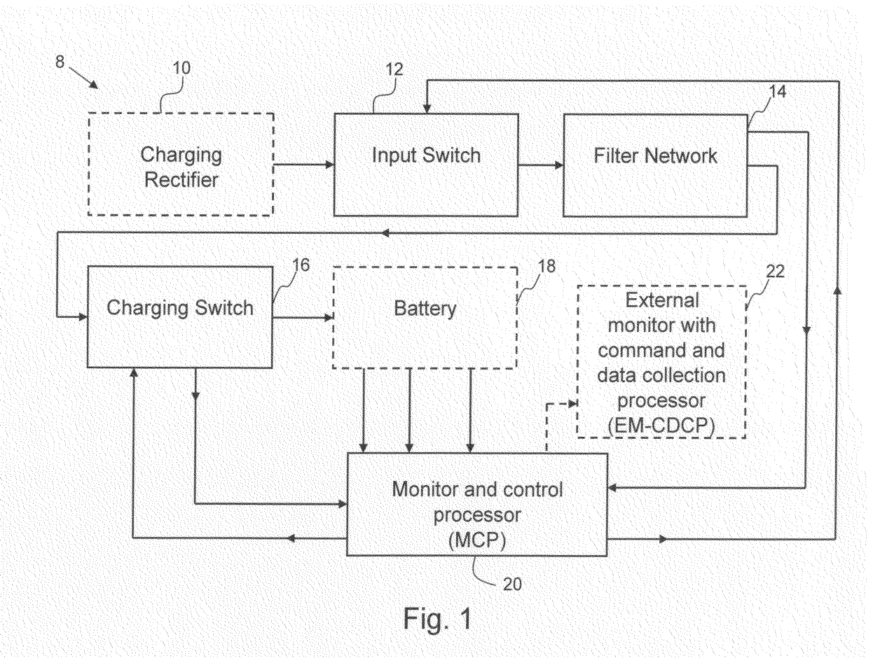

FIG. 1 shows an exemplary embodiment of a formation and charging controller system 8 for charging a battery 18. The formation controller system 8 includes a charging rectifier 10, an input switch 12, a filter network 14, a charging switch 16 and a monitor and control processor (MCP) 20. The formation controller system 8 can also include an external monitor 22. The charging rectifier 10 can be an existing charging rectifier available at the customer facility, or one provided with the formation controller system 8. The charging rectifier 10 provides direct current to the input switch 12 which is controlled by the MCP 20. The switched current from the input switch 12 is applied to the filter network 14. An isolated voltage sample from the filter network 14 is provided to the MCP 20. The current from the filter network 14 is then sent to the charging switch 16. The charging switch 16 is also controlled by the MCP 20. An isolated current sample from the charging switch 16 is passed to the MCP 20. The current from the charging switch 16 is then delivered to the battery 18 whose temperature is monitored by the MCP 20. The battery 18 can be in many forms, for example, one or more batteries, or one or more cells, in separate or combined containers. The MCP 20 uses the voltage, current and temperature samples to control the charging process for the battery 18. The MCP 20 may be connected (singularly or in multiplicity) to an external monitor, command and data collection processor 22.

In some embodiments, the direct current power source 10 can provide up to 600 volts at current levels of 5 to 500 amps on a continuous basis, and not be under current control. Depending on the application, voltage levels of the power supply 10 may be varied to adaptively lower the input voltage to the battery 18 to reduce battery heating, and to reduce total power consumed during the charge cycle. The power supply 10 can be a linear silicon controlled rectifier (SCR) based DC power supply.

The input switch 12 controls the voltage provided to the filter network 14. The voltage on the filter network 14 is monitored by an isolated voltage measurement device monitored by the MCP 20. The input switch 12 can replace the charging rectifier voltage control sub-system. The input switch 12 also eliminates interfacing issues presented by the wide variety of rectifier manufacturers and control methodologies.

The filter network 14 reduces or eliminates any line-frequency AC components from the charging current supply and provides a stable voltage that is largely independent of input power fluctuations. The filter network 14 also provides an isolated voltage sample to the MCP 20.

The output voltage of the filter network 14 is controlled by the charging switch 16 which is also monitored by an isolated voltage measurement device as well as an isolated current measurement device, both of which are monitored by the MCP 20. The charging switch 16 controls the current that is delivered to the battery 18. In some embodiments, the charging switch 16 is an insulated gate bipolar transistor (IGBT) device, which is well known in the art and allows for quick and repetitive cycling to generate high energy charge pulses during the charging cycle.

The MCP 20 can monitor isolated voltage samples from the input switch 12, the filter network 14 and the battery 18; monitor isolated current samples from the charging switch 16; and monitor isolated temperature sensors external to battery 18. These measurements can be used by the MCP 20 in various calculations to determine the amount of charge acceptance, the end of charge cycle, electrochemistry latency, battery internal resistance, and heat rise over ambient. These calculations can then be used by the MCP 20 to control both the input switch 12 and the charging switch 16 in such a manner as to perform an efficient charge of the battery 18 within the desired time. The MCP 20 can also provide this data to the external monitor, command and data collection processor 22.

The MCP 20 can calculate the desired control levels for the input switch 12 and the charging switch 16. The MCP 20 can also calculate the desired charge frequency and energy while maintaining battery temperature in a desired range during the charge cycle. The MCP 20 can calculate charge cycle completion by a singular or a multitude of measured and calculated variables. The MCP 20 can also prevent operation at resonance frequencies, and detect a variety of charge cycle errors, including open circuits, loose connections, and run away currents.

The MCP 20 can include an output device, such as a display, and an input device, such as a keypad. In embodiments with an output device, the MCP 20 can provide real-time status and data on the output device. In embodiments with an input device, the MCP 20 can accept command data from the input device. The MCP 20 can also accept command data from the external monitor, command and data collection processor 22.

The external processor 22 can provide facility-wide data collection, monitoring and control of one or a series of formation controller systems 8, and can provide data analysis tools for quality control measures. The external processor 22 can also provide real-time process optimization data, historical data for post-mortem failure analysis, and both real-time and historical data for engineering trials without interfering with production control.

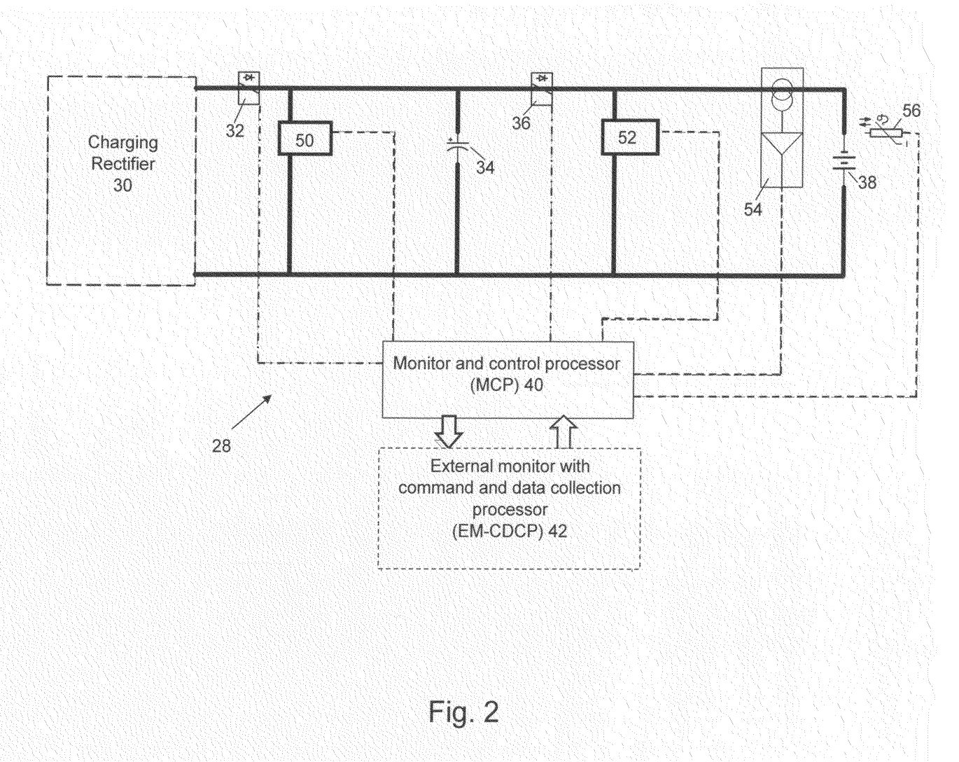

FIG. 2 illustrates a schematic of an embodiment of a charging and formation controller system 28 for charging a battery 38. The formation controller system 28 includes a charging rectifier 30, an input switch 32, a filter network 34, a charge switch 36, an MCP 40, voltage sensors 50 and 52, a current sensor 54 and a temperature sensor 56. The MCP 40 can also be connected to an external monitor with command and data collection processor 42.

The charging and formation controller system 28 is powered by the charging rectifier 30, which can be a silicon controlled rectifier-based linear direct current power supply. The output of the power supply 30 is controlled by the input switch 32 which provides control of the applied voltage. The switched voltage controlled by the input switch 32 is applied to the filter network 34 which reduces or eliminates line-frequency components, and thereby provides a stable voltage that is largely independent on input power fluctuations. The voltage sensor 50 monitors the applied voltage by the input switch 32 across the filter network 34 and provides these voltage measurements to the MCP 40. The charging voltage is then applied to the charging switch 36 which regulates the current supplied to the battery 38. The voltage sensor 52 monitors the charging voltage applied by the charging switch 36 across the battery 38, and the current sensor 54 monitors the current controlled by the charging switch 36 to the battery 38. The measurements of the voltage sensor 52 and the current sensor 54 are monitored by the MCP 40. The MCP 40 also monitors the measurements of the temperature sensor 56. The MCP 40 uses the measurements of the voltage sensors 50 and 52, the current sensor 54 and the temperature sensor 56 in controlling the operation of the input switch 12 and the charging switch 16. The MCP 40 can also provide status and data to the external monitor 42, as well as providing real-time status and data on a process display. The MCP 40 can also accept command data from the external monitor 42.

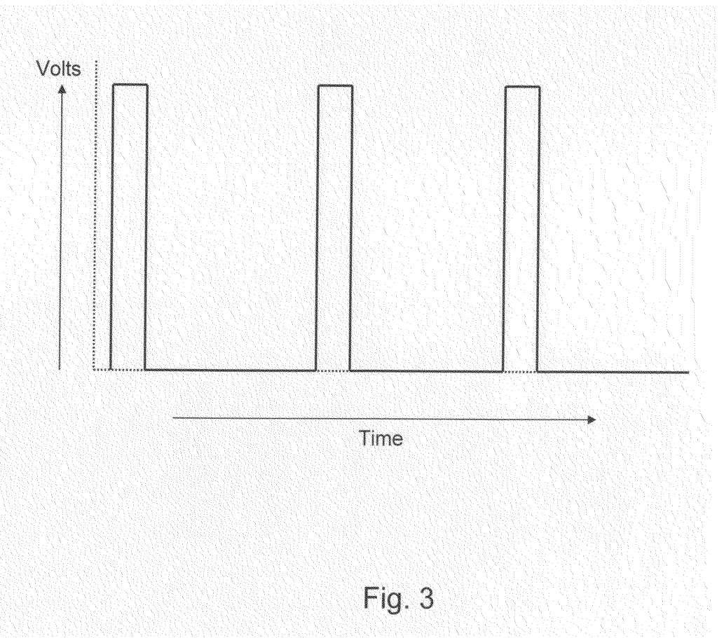

FIG. 3 illustrates an exemplary voltage waveform output by the charging and formation controller system 28 of FIG. 2 to the battery 38. Starting from an initial point, a short duration pulse is applied to the battery 38 undergoing charging and/or formation. The internal resistance of the battery 38 is calculated from the readings of the voltage sensor 52 and the current sensor 54 and stored by the MCP 40 and/or the external monitor 42. The battery terminal temperature from the temperature sensor 56 and the ambient temperature are also measured and stored by the MCP 40 and/or the external monitor 42. After an initial delay time, the pulse is repeated, and the resistance calculation and temperature measurements are also repeated and stored. When a programmable number of samples have been taken, additional calculations are made to determine whether to change the pulse width, pulse repetition rate (frequency), and/or the applied voltage. The end of charge may be determined by changes in the internal resistance of the battery over time, open circuit voltage, total amp hours accepted, change in electrochemical latency, or any combination of the above.

The adaptive control software embedded in the MCP controls the operation of the charging and formation system. The MCP software controls the measurement of isolated voltage and current samples. The battery voltage and charging currents can be monitored and, depending on the charge type, can be controlled to a set point determined by the MCP or the external monitor. The MCP software can also control the measurement of isolated temperature samples provided by external sensors. The battery temperature can be monitored and the charge cycle modified to maintain the battery temperature in a desired range. Additionally, embedded hardware temperature sensors can be used to prevent the components of the charging and formation system from overheating. These embedded sensors can be used to modify the charge cycle to maintain hardware temperatures in an acceptable range without stopping the charging cycle.

The MCP software can also control the input switch operation and calculate input switch control levels. The input switch can include a mechanical disconnect means (power contactor) to safely allow removal of power used for charging. Optionally, the input switch can also include a variable SCR to allow for variable input voltage to the filter network. The MCP software can verify that the input voltages are proper for the charge cycle selected. The input voltage levels can be controlled from, for example, 12V to 600V to provide the desired input voltage for the selected charge cycle.

The MCP software can also control the charging switch operation and calculate charging switch control levels. The charging switch can be a solid state transistor device, such as an IGBT device, that allows for quick and repetitive cycling on and off to generate the actual high energy charge pulses during the charging cycle. The on/off cycling of the charging switch can be controlled in one of the following methods: variable frequency/fixed pulse width or fixed frequency/variable pulse width. In either charging method, the variable element (frequency or pulse width) can be varied to maintain the selected charge current.

The MCP software can also calculate the desired charge frequency. Due to resonance and other factors, different frequencies have varying effects on the charge cycle. When charging in variable frequency/fixed pulse width mode, the MCP software can automatically determine an efficient charging frequency. This charging frequency can be automatically monitored and adjusted throughout the charge cycle to maintain an efficient charging frequency.

The MCP software can also calculate the desired charge energy. The charge cycle usually includes at least one of two major charging step types: fixed current charging or minimum energy charging. In fixed current charging, various constant current steps (fixed frequency or fixed pulse width) are entered into the system to execute the charge cycle. The fixed current method is usually the quickest method of charging batteries, but usually requires more energy since feedback from the batteries as to charge status is ignored. Minimum energy charging automatically monitors the battery's state of charge and adjusts the charge cycle to maintain a minimum energy usage to complete the charge cycle. The minimum energy method usually takes more time, but minimizes the energy utilized to complete the charge cycle.

The MCP can also determine charging step completion based on energy placed into the batteries. This is accomplished by monitoring the watts/watt-Hours of energy placed into the batteries. Watts and Watt-Hours are calculated by multiplying the Bus Voltage by the charging Current.

Traditional chargers rely on Amp-Hours to determine battery charge completion. This is based on the theory that initial battery formation requires current for the chemical conversion process. This theory generated equations that determined the minimum amount of current required for a given amount of lead oxide. The process disclosed herein shows that this current based theory is not optimal. Pulse charging can fully form batteries in less than the theoretical current (Amp-Hrs). This process shows that battery formation can be the function of power input to the battery not just the amount of current placed into the battery.

The MCP software can also maintain the desired battery temperature during the charge cycle. By utilizing battery temperature feedback, the system can maintain the selected battery charging temperature. The charging cycle can be modified to maintain the battery temperature in the desired range. This method increases the efficiency (acceptance of charge by the battery) throughout the charge cycle.

The MCP software can calculate charge cycle completion by one or more measured and calculated variables. The completion of individual charge steps or the entire charge cycle can be determined by time, energy applied, or battery state of charge, or any combination of these or other parameters.

In order to prevent operation at resonance frequencies, the MCP software can automatically detect and skip resonance frequencies to prevent undesirable effects on the batteries and/or the system. The MCP software can also detect a variety of other charge cycle errors. The MCP can include full diagnostic capability to prevent undesired operations, including the ability to detect battery open circuits, loose connections, or short circuits. These diagnostic alerts can also be passed to the external monitoring processor. Depending on the severity of the error, the MCP can cause the system to automatically pause or terminate the charging cycle.

The MCP software can provide status and data to an external monitor, and can accept command data from an external monitor. This status data can be made available for display or storage across a standard Ethernet or other network, local or wide-area, enabling multiple terminals or data storage servers to access this status data. Additionally, each charging cycle can be given a unique batch identifier to enable storage and tracking of the charging cycle for historic and archival proposes. The external processor can start, stop, pause, and download a variety of operational data parameters to the MCP, including complex charge cycles

The MCP can also include input and output devices to allow for operation and status monitoring without the need for an external processor. An output device, such as a display, can provide real-time status and data. Input devices, such as a keyboard and/or mouse, can be used with the display to control the formation and charging system, including entry or selection of command data and creation of charge cycles.

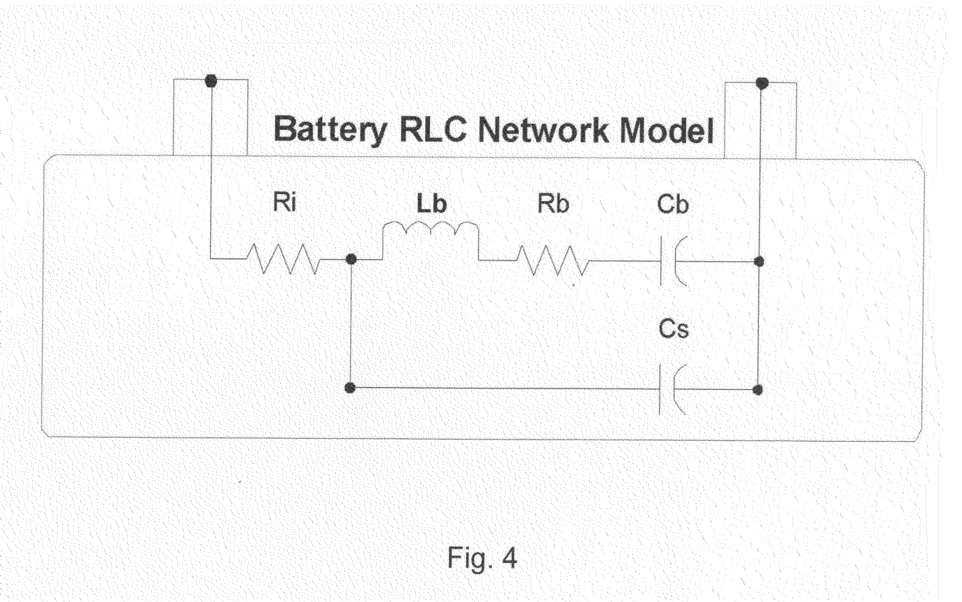

To better understand the charging cycle for a battery, a battery RLC network model is illustrated in FIG. 4. In this model, Ri represents the internal resistance presented by the grids, straps, internal welds, terminals, etc. of the battery; Lb represents the delay in bulk charge current flow; Rb represents the electrochemical resistance created by the mass transport reaction and limited by the active material, acid and separators; Cb represents the bulk (deep cycle) charge, and Cs represents the surface charge.

When a load is placed across the battery terminals, maximum current flow is initially limited by Cs and Ri. The capacity of Cs is governed by battery design, and is quickly depleted. Current flow from Cb is limited by Rb, Lb, and Ri. Due to Rb and Lb, the current flow from Cb starts much slower than the current flow from Cs. When the load is removed, the charge on Cs is replenished by Cb through Rb and Lb.

In existing charging systems, a constant potential is applied across the battery terminals. Cs receives an immediate charge. Cb requires a much longer time period to charge, at a higher potential than Cb (due to Rb). This higher potential is the mechanism for hydrolyzation of the electrolyte (a condition where the water is split into hydrogen and oxygen) and corrosion of the positive plate material (where material is electroplated from the positive plate, strap and terminal material to the negative plate, strap and terminal material), since Cs has taken all the energy it can store. This concept is more easily understood if Cs is removed from the network model after it has achieved full charge acceptance.

Embodiments of the present invention can use a short-duration, high-current pulse placed across the battery terminals to charges Cs. The input current is then interrupted, and the charge on Cs is transferred to Cb through Lb and Rb until Cb and Cs are at the same potential. Another pulse is then placed across the battery terminals, and the process repeats until Cb and Cs can no longer accept a charge. Hydrolyzation and corrosion do not occur since there is not the difference in potential or the available excess electrons. Heat produced from hydrolyzation and corrosion is not liberated, allowing the battery under charge to remain at roughly ambient temperatures without extensive external cooling efforts. There is some minor heating due to the ohmic (I²R) losses in Ri and Rb.

This charging current can be in the form of high current pulses on the order of 5 to 50 times the total amp-hour capacity of the battery undergoing charge. The high current pulses can have pulse widths on the order of 1 μsec to 7 msec wide, and repetition rates on the order of 13 msec to 50 μsec. The applied voltage can be on the order of 1 to 6 times the nominal cell open circuit voltage.

The determination as to when the battery is fully charged may be made by one of several mechanisms. For example, change in terminal voltage over a period after charging current ceases (Delta V/T); internal battery resistance change over a period of time (Delta Ω/T); total amp hours accepted (coulomb counting); change in battery temperature over time (Delta Temp/T); or final specific gravity as a function of open circuit voltage.

Rb, Ri and Lb are all dynamic elements in that they change throughout the charging cycle. Thus, a fixed charging algorithm will only optimize charging efficiency for a small portion of the charging cycle. An adaptive charging algorithm can optimize the charging efficiency throughout the entire charging cycle.

Battery temperature measurement can also be a problem. Lead is a good conductor of heat, having a thermal conductivity of 34.7 W/mK, while polypropylene (a typical battery case material) has a thermal conductivity of 0.12 W/mK. Thus, battery case temperature measurements are a poor method of determining internal battery temperatures. In many instances, probes or thermometers are inserted into the electrolyte solution to measure internal battery temperature. If using acid-immobilized or gelled electrolyte battery designs, an accurate electrolyte temperature may not be obtainable. Any attempted temperature measurement of the active battery material is affected by the state of charge; operator skill and accuracy; and the presence or absence of lead sulfate and/or lead oxide on the battery element.

By measuring the battery post temperature, the temperature measurement is nearly identical to that inside the battery. In addition, the battery terminal is not undergoing a rapid electrochemical conversion, and maintains a substantially consistent thermal conductivity throughout the charging cycle. This also eliminates unnecessary operator exposure to the electrolyte, and reduces or eliminates acid release to the environment (usually occurring as droplets from the temperature sensor or thermometer). Measurement accuracy is improved from an interpolated +/−2° C. (alcohol thermometer) to +/−0.1° C. (silicon-based temperature sensor), as well as eliminating the human error factors involved in existing temperature measurement systems. Since this method tracks temperature changes over time, absolute accuracy is not critical. Thus, calibration may be replaced with qualification, e.g., using a non-contact infrared pyrometer to compare with measured temperature readings.

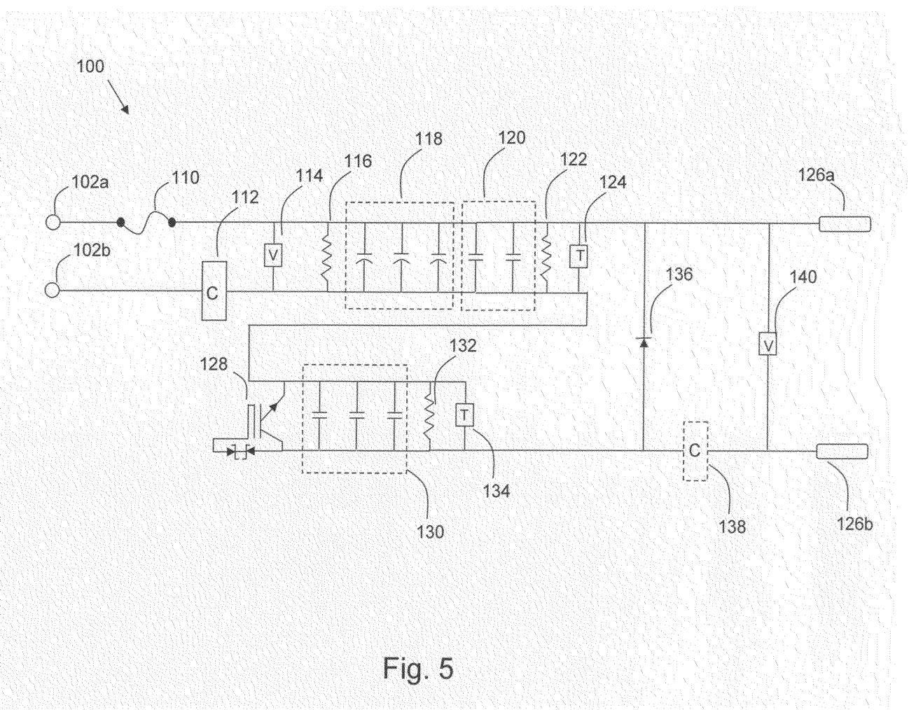

Referring to FIG. 5, an embodiment of the current teachings is shown. Terminals 102a and 102b connect the circuit shown in FIG. 5 to a charging rectifier (not shown). Fuse 110 ensures the circuit of FIG. 5 is not exposed to excessive current. In one embodiment a fast-blow fuse is used to immediately cutoff flow of current in case of excessive current. Current sensor 112 is used to measure the series current of the loop between terminals 102a and 102b. Voltage sensor 114 is used to measure the voltage across terminals 102a and 102b.

Resistors 116 and 122 situated between terminals 102a and 102b are bleed off resistors used to bleed off voltage in the electrolytic capacitors after voltage is removed from terminals 102a and 102b. Electrolytic capacitors are also positioned between terminals 102a and 102b. An electrolytic capacitor bank 118, otherwise known as “bus-caps”, are used to substantially remove electrical noise from the supply lines across terminals 102a and 102b. Use of one electrolytic capacitor, as is common in the prior art, will disadvantageously result in overheating of the electrolytic capacitor, which results in premature failure of the capacitor, as is well known to those skilled in the art. To prevent this from occurring, the current embodiment uses several electrolytic capacitors 118 as shown in FIG. 5. The parallel combination of the capacitors results in the same capacitance as one larger electrolytic capacitor. This embodiment also includes a second bank of capacitors 120, of smaller capacitance used as a frequency cutoff filter. This frequency cutoff capacitor bank 120 suppresses high frequency components existing across terminals 102a and 102b. The lower capacitance of these capacitors 120 places a small impedance at high frequencies across terminals 102a and 102b to allow suppression of energy due to the high frequency noise. A temperature sensor 124 is positioned proximate to capacitor banks 118 and 120 and can be used to monitor the temperature of this area of the system and make adjustments if necessary.

A switching device 128 is under the control of a micro-controller (not shown). In some embodiments an IGBT is used to switch the current off and on. A snubber capacitor bank 130 is used as a frequency cutoff filter similar to the capacitor bank 120. A bleed off resistor 132 is used to bleed voltage off the capacitor bank 120 after the circuit is turned off. A temperature sensor 134 is positioned proximate to the snubber capacitor bank 130 to monitor the temperature of the snubber capacitor bank 130. Switching devices are often equipped with flyback diodes. A flyback diode 136 is used to suppress flyback pulses in conjunction with the flyback diode of the switching device 128. Whether the switching frequency of the switching device is substantially the same as the natural frequency of the system, or a plurality of batteries connected at terminals 126a and 126b are at the beginning of the formation phase, current reflections can heat switching device 128. The snubber capacitor bank 130 is used to suppress the high frequency components of current reflection to preserve the switching device 128. Additionally, when the switching device 128 switches off and on, the capacitor bank 130 is used to suppress the ringing that is the result of sudden switching of current. Optional placement of a current sensor 112 is shown in phantom as reference numeral 138. A voltage sensor 140 senses voltage directly at the battery terminals 126a and 126b.

A profile or recipe for battery formation or charging includes a series of one or more active steps. Some exemplary profile step type definitions are provided in Appendix A, including an automatic charge to voltage step type, an automatic completion step type, a fully automatic step type, a constant current step type, a constant current-fixed frequency step type, a rest step type and an automatic rest step type. These or other steps can be put together to create a profile or recipe.

The automatic charge to voltage step type charges at a specified current level until the battery string voltage reaches a specified target voltage in the step. This step type does not have a time or power limit. If the target voltage is chosen incorrectly, this step will continue until a maximum profile power is reached.

The automatic completion step type charges at a specified current level until the battery string voltage reaches a specified target voltage. When the target voltage is reached, the charging rate drops to maintain the voltage level until a finish threshold value is reached. The finish threshold value can be a frequency threshold or a current threshold. This step does not have a time or power limit. If the target voltage or finish threshold values are chosen incorrectly, this step will continue until a maximum profile power is reached

The fully automatic step type forms out the batteries using a single fully automatic step. This step does not have a time or power limit. If the target voltages or finish threshold values are chosen incorrectly, this step will continue until a maximum profile power is reached. This step includes three separate phases. The first phase starts the formation by slowly ramping up the current over a set time period before increasing the charge rate to the full current setpoint. The second phase is an automatic completion step (described above) with a frequency threshold. When the battery voltage for this phase is reached, the current is reduced to maintain the battery voltage until a low frequency threshold is met. The end of this second phase coincides with the negative plate form out. The third phase is also an automatic completion step but with a current threshold. When the battery voltage for this phase is reached, the current is reduced to maintain the battery voltage until a low current threshold is met. During this phase, the positive plates form out and the battery is charged to its final state of charge. The end of the third phase coincides with the completion of the battery formation.

The constant current step type charges at the specified current level until a threshold value is met. This step utilizes a fixed pulse width while varying the frequency to maintain the selected charge current rate. The threshold for this step can be (1) time, (2) A-Hrs for this step, (3) W-Hrs for this step, (4) Total A-Hrs for the entire profile, or (5) Total W-Hrs for the entire profile. One of the last two threshold types may be useful after an automatic step to insure that a minimum number of A-Hrs or W-Hrs have been placed into the batteries. If the total number of A-Hrs (or W-Hrs) for the current formation already exceeds the A-hrs (or W-Hrs) value for this total threshold type, then the step completes immediately

The constant current, fixed frequency step type charges at the specified current level until a threshold value is met. This step utilizes a fixed frequency while varying the pulse width to maintain the selected charge current rate. The threshold for this step can be (1) time, (2) A-Hrs for this step, (3) W-Hrs for this step, (4) Total A-Hrs for the entire profile, or (5) Total W-Hrs for the entire profile. One of the last two threshold types may be useful after an automatic step to insure that a minimum number of A-Hrs or W-Hrs have been placed into the batteries. If the total number of A-Hrs (or W-Hrs) for the current formation already exceeds the A-hrs (or W-Hrs) value for this total threshold type, then the step completes immediately.

The rest step type pauses charging for a specified time period. The automatic rest step type pauses charging until the battery temperature is below a specified temperature threshold. If the battery temperature is already below the specified temperature threshold when this step is started, then the step completes immediately.

Appendix B provides an exemplary recipe or profile. The data is listed on the left and explanatory comments are provided on each line following the ‘\’ character. This exemplary recipe includes a plurality of active steps for a fixed pulse width profile. The profile has global parameters setting a maximum power value for the profile and a maximum snubber capacitor temperature for the profile. These parameters are active during each of the steps of the profile.

The first step of this exemplary profile is a constant current step with a current setpoint of 10 A for a duration of 5 A-Hrs. During this step, the maximum battery temperature is 170° F., the maximum frequency is 7000 Hz and the pulse width is set to 40 μsec.

The second step of this exemplary profile is a constant current step that increases the current setpoint to 15 A for an additional 5 A-Hrs. The maximum battery temperature and frequency are kept the same as the first step. The pulse width is increased to 45 μsec.

The third step of this exemplary profile is a constant current step that increases the current setpoint to 20 A for an additional 50 A-Hrs. The maximum battery temperature and frequency are kept the same. The pulse width is increased again to 50 μsec.

The fourth step of this exemplary profile is a constant current step that increases the current setpoint to 30 A for an additional 50 A-Hrs. The maximum battery temperature and frequency are kept the same. The pulse width is increased further to 80 μsec.

The fifth step of this exemplary profile is a constant current step that increases the current setpoint to 35 A for an additional 100 A-Hrs. The maximum battery temperature and frequency are kept the same. The pulse width is increased further to 85 μsec.

The sixth step of this exemplary profile is a constant current step that increases the current setpoint to 40 A for an additional 125 A-Hrs. The maximum battery temperature and frequency are kept the same. The pulse width is maintained at 85 μsec.

The seventh step of this exemplary profile is a constant current step that decreases the current setpoint to 35 A for an additional 120 A-Hrs. The maximum battery temperature and frequency are kept the same. The pulse width is decreased to 80 μsec.

The eighth step of this exemplary profile is a constant current step that decreases the current setpoint to 30 A for an additional 160 A-Hrs. The maximum battery temperature and frequency are kept the same. The pulse width is maintained at 80 μsec.

The ninth step of this exemplary profile is a constant current step that decreases the current setpoint to 25 A for an additional 75 A-Hrs. The maximum frequency is kept the same, but the maximum battery temperature is reduced to 160° F. The pulse width is decreased to 70 μsec.

The tenth and last step of this exemplary profile is also a constant current step that decreases the current setpoint to 10 A for an additional 10 A-Hrs. The maximum battery temperature and frequency are kept the same as in the previous step. The pulse width is decreased to 50 μsec.

Many recipes include temperature limits. The more current the system tries to put into the battery, the more the temperatures will rise. When running a first formation trial on a battery, the temperature limits, which could for example be 150 degrees Fahrenheit, are not usually reached. Then on further trials, the temperature can be allowed to go higher which allows more current to be put into the battery faster and gets the formation done faster. Successive trials can use different temperature limits to determine a preferred temperature limit to meet charging goals. Some possible charging goals can include charging in less time or charging using less power.

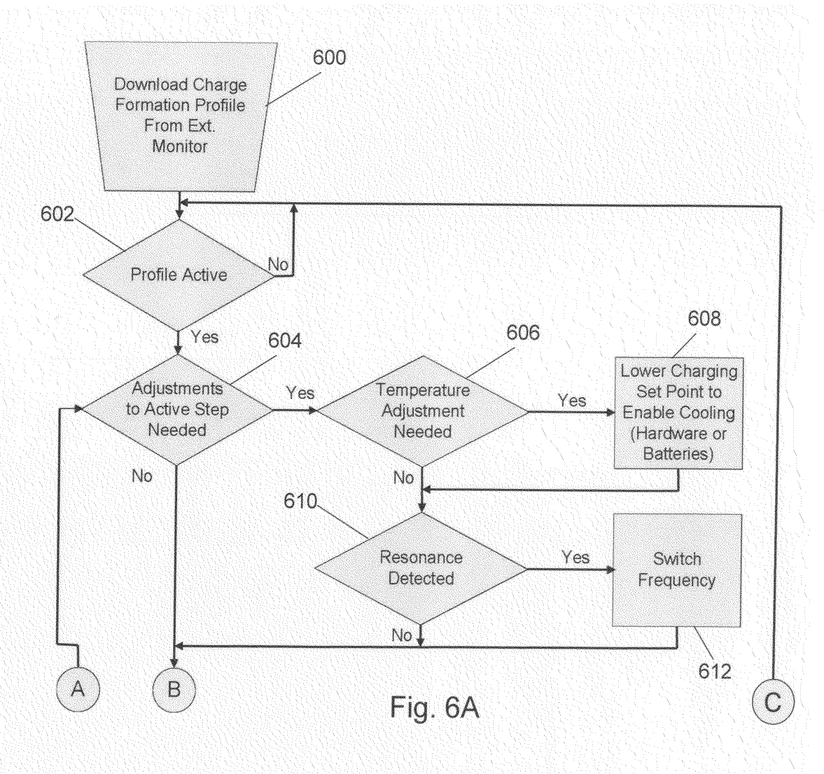

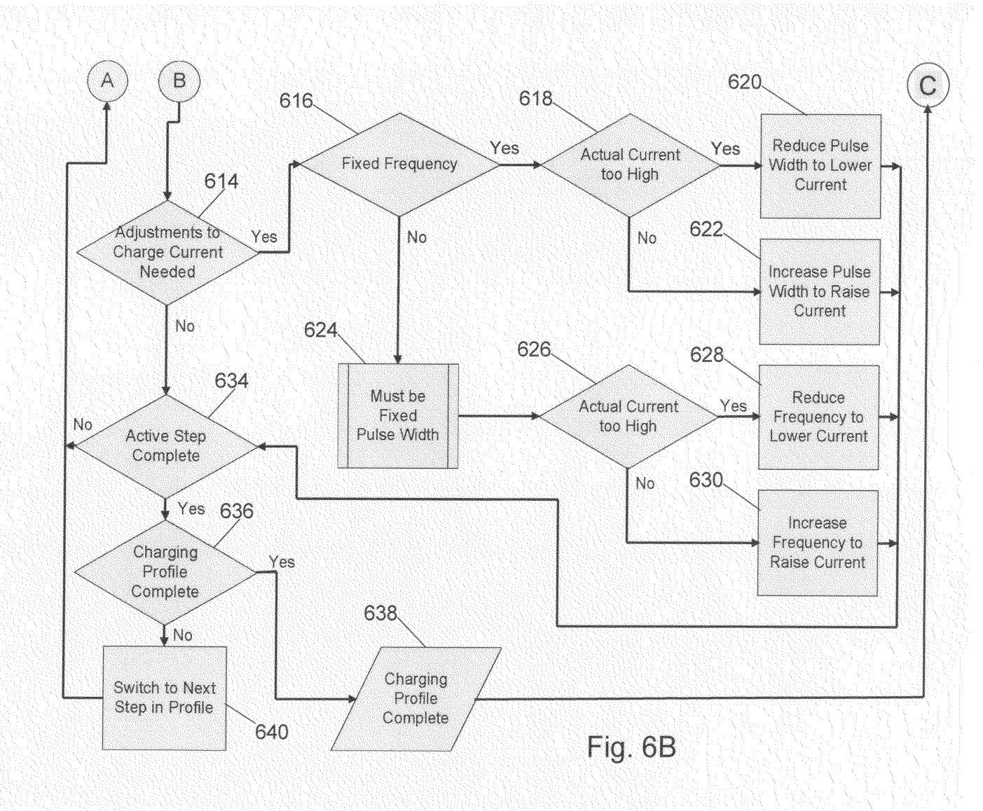

FIGS. 6A and 6B provide an exemplary high-level flow chart for a charging and formation control system. At step 600, a charge formation profile is loaded into the system. The profile can be provided locally at the MCP or downloaded from an external monitor. At step 602, the system checks whether there is an active profile. If there is not an active profile, control stays at step 602 until there is an active profile. When there is an active profile, control is transferred to step 604 which initially starts with the first step of the profile.

At step 604, the system checks whether adjustments to the active step are needed. The system can sense an adjustment is necessary to the active step based on sensor inputs, for example from temperature, voltage or current sensors. For example, if a monitored temperature exceeds an applicable temperature limit for the active step, or if a monitored voltage exceeds a voltage limit for the active step, then the system will make an adjustment. If no adjustment is needed control is transferred to step 614. If an adjustment is needed, control is transferred to step 606.

At step 606, the system checks whether a temperature adjustment is needed. This temperature adjustment could be due to the battery temperature or a system hardware temperature exceeding a temperature limit for the active step. If a temperature adjustment is needed, control is transferred to step 608 where the charging set point is lowered to enable cooling. After the adjustment is made or if no temperature adjustment is needed, control is transferred to step 610.

The charging can be lowered by lowering the charging current. The amount of current adjustment can be based on the sensed temperature difference from the desired set point. For example, if the temperature difference is 1 degree, then the charging current can be reduced to a first level; and if the temperature difference is 2 degrees, then the charging current can be reduced to a lower second level, and so on. If the sensed temperature difference remains the same, then the charging current does not change from the present adjusted current level. Of course, the temperature sensor can have greater sensitivity than 1 degree increments.

In other exemplary control flow embodiments, other checks can be made instead of or in addition to the temperature check of step 606. For example, if a profile step calls for maintaining the battery voltage at a particular level, then a change sensed by the battery voltage sensor can trigger an adjustment by the system. Again, the adjustment can be made based on the difference from the desired set point.

At step 610, the system determines whether there is resonance. Resonance can be detected by the system hardware temperature. Resonance is frequency based, and changes as the battery is forming. If the hardware temperature reaches its maximum limit such that the temperature adjustment is necessary because of the hardware, then it can be assumed that the system is in resonance. If resonance is detected, then at step 612 a new frequency is selected. If no resonance is detected or after the frequency switch is complete, then control is transferred to step 614.

Step 612 can include different methods to determine a new frequency that is not a resonance frequency. One method is to randomly switch to another allowable frequency and continue to do so until resonance is no longer detected. Alternatively, a sweep through the frequencies can be performed to find a frequency at which the charging is the most efficient at that time in battery formation, and then move the frequency to that newly found frequency. There can be a natural frequency of a given battery or battery string, and there can also be a harmonic type of situation that is a combination of the battery, the system hardware, the charging means, and other elements of the system.

The frequency sweep can be made over a given range, say between 5,000 and 7,000 Hz, as opposed to the entire frequency range. The limits for this frequency range can be based on harmonics found earlier in the charging step or profile, or on previous implementations of the profile for a given battery type. For a certain battery type, there might be a resonance frequency at 8500 hertz and the frequency sweep can be done from 6,000 to 9,000 Hertz. If 6,500 hertz looks to be the best frequency, then it can be used as a max or preferred frequency value for that battery type. Avoiding resonance frequencies enables more charging efficiency and protects the hardware at the same time.

The system can sweep the frequencies to find the most efficient frequency by monitoring the current sensor. A pulse width is maintained while the system sweeps through a frequency range, and the system tracks the current that can be transferred to the battery at the different frequencies in the swept frequency range. At resonance, the current will drop relatively significantly, possibly 15-20%.

The whole circuit, including the batteries and other components, can not accept the current as well when a resonance frequency is encountered. A high temperature usually indicates the reflecting back of the current or the energy which causes the hardware to heat up. When the system is not in resonance and when it is charging efficiently, the temperatures of the hardware is nearly ambient. When the system hits a resonance frequency, the snubber capacitors and the flyback diodes start having to try to dissipate that reflected energy which causes elements of the system to heat up. A temperature sensor on the snubber capacitors and diodes near the IGBT, can be used to indicate resonance.

In the corrective action section of the control software, the system can determine what is getting hot, the battery or some other hardware components. Different corrective actions can be taken depending on what is getting hot, or the same corrective action could be taken but at different rates. For example, if the battery temperature exceeds a threshold, the current can be decreased by a first amount, while if some other hardware component exceeds its threshold temperature, the current can be decreased by a second amount. For instance, when you first form the batteries, they don't like a lot of current to start with. It reflects back on the hardware and it reflects back similar to resonance. So we usually start formation slow and low with the current.

At step 614, the system checks whether a change to the charge current is needed. When a change is needed, control is transferred to step 616. If a change is not needed, control is transferred to step 634.

At step 616, the system determines whether this active step is using a fixed frequency. If the step is using a fixed frequency, control is transferred to step 618. If the step is not using a fixed frequency, control is transferred to step 624.

At step 618, the system determines whether the actual current is too high. If the actual current is too high, control is transferred to step 620 where the current pulse width is decreased to lower the current and then control is transferred to step 634. If the actual current is not too high, control is transferred to step 622 where the current pulse width is increased to raise the current and then control is transferred to step 634

At step 624, the system determines that this active step is using a fixed pulse width and control is transferred to step 626. At step 626 the system determines whether the actual current is too high. If the actual current is too high, control is transferred to step 628 where the frequency is decreased to lower the current and then control is transferred to step 634. If the actual current is not too high, control is transferred to step 630 where the frequency is increased to raise the current and then control is transferred to step 634

When the current is adjusted, whether it is adjusted by changing the frequency or changing the pulse with, it is usually a proportional increase or decrease to the current. Then when the temperature sensor is monitored on the next cycle, the difference from the threshold is again evaluated and the software determines whether additional adjustment is needed. In this embodiment, the adjustment is not changed if the difference remains the same, but if the difference changes then the system determines whether additional adjustment is needed. In some embodiments the control software cycles through its monitoring once per second, but different cycle times can be used.

For example, if the maximum current set point for the first step is 30 amps, when the system first begins charging the batteries it starts from zero amps. The system senses a difference of 30 amps between the actual and desired current, so a large frequency or pulse width change is made. If the active step uses a fixed frequency of 6500 hertz with a variable pulse width within a certain range, with a max current of 30 amps and a max battery temperature of 150 degrees, the control software accounts for all of these parameters and starts ramping up to 30 amps by adjusting the pulse width until it gets to 30 amps on the fixed frequency. As the current approaches 30 amps, the difference decreases and the system starts to pull back on the adjustment by making the pulse width change a little smaller. Eventually the system stabilizes around the desired 30 amp level, and checks the current again every cycle. If the current goes down to 29.5 amps then the system will increase the pulse width; and if the current goes up to 30.5 amps then the system will decrease the pulse width within the desired pulse width range. In the meantime, the system will also be checking the battery and other temperatures or voltages and taking corrective actions if they exceed their thresholds.

At step 634, the system determines whether it has reached the end of the active step of the profile. Within the profile there are usually multiple steps and each step might have a different temperature limit, current limit, voltage limit or other parameter differences. So as the system moves from one step to the next, it will adjust the current or other parameters accordingly. If the active step is not complete, control is transferred back to step 604. If the active step is complete, control is transferred to step 636.

At step 636, the system determines whether it has reached the end of the entire charging profile. If it has not reached the end of the profile, at step 640 the system makes the next step in the profile into the active step and control is transferred back to step 604 to progress through the new active step. If the charging profile is complete, then control is transferred back to step 602 to await a new profile.

The end of step determination can be made as a function of several parameters, including power, current, or time. For example, the step could be set to end after a given time duration. Alternatively, the step could be set to end after a certain number of amp-hours or watt-hours during that particular step or since the beginning of the profile.

Since the system is usually most interested in the energy that can be transferred into the battery, the steps are usually ended based on energy transfer, such as amp-hours or watt-hours, instead of time duration. So the system monitors the cumulative power that is put into the battery during the step and/or up to that point in the profile and that value can be used as the set point to determine when to move to the next step. However, it may be desirable in particular situations to have a time dependent step, such as a rest step.

When performing a fixed frequency step, the system can sweep a frequency range to find the frequency that it wants to stay at for the step. Instead of a certain frequency for an entire fixed frequency step, the system can have steps with a frequency range, for example 5,000-7,000 Hz range, and then the system can sweep that frequency range and find the most efficient frequency. Once the system finds the desired frequency for a step, it can stay at that frequency or periodically make another sweep through the frequency range to see if a more desirable frequency can be found. The desired frequency often changes during battery formation and charging as the battery properties change. It is not uncommon, for the resonance frequency to change by 500 hertz or more through the course of formation. Thus, the most efficient frequency is likely to also change during charging. The system can be set to sweep through the frequency range after a certain time or based on some other parameter to determine if a more efficient frequency can be found.

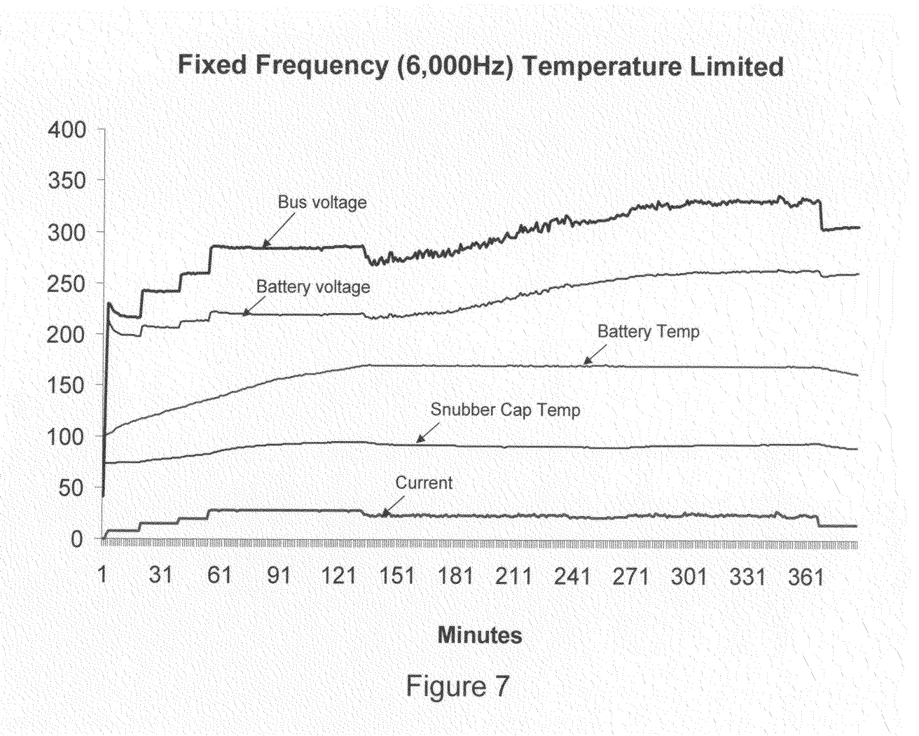

FIGS. 7-9 show graphs of several monitored parameters during charging using different profiles. FIG. 7 plots some of the monitored parameters when the system has a fixed frequency of 6,000 hertz and is temperature limited. At the beginning of the charging process, the current is increased and the other parameters increase as well. The monitored voltages closely mirror the current increases and the monitored temperatures increase more gradually. When the battery temperature reaches a threshold of about 170 degrees, the current is lowered to keep the battery temperature from going over this temperature limit. Initially the voltages decrease with the current, but they then start to ramp up until a certain energy transfer or time limit is met for the profile and the current is lowered at the end of the profile.

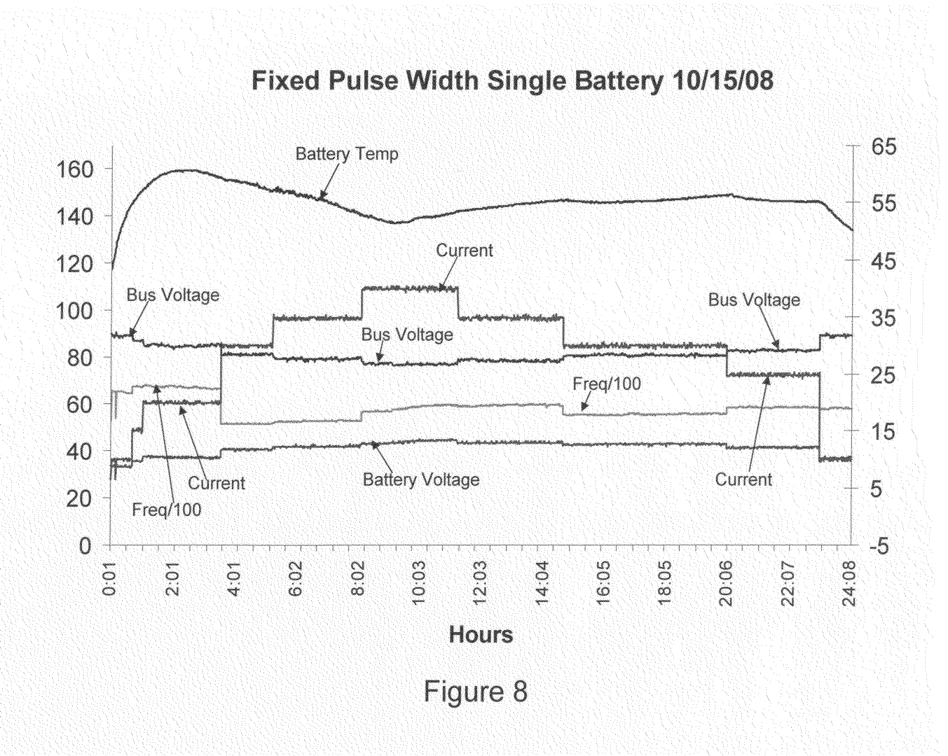

FIG. 8 plots some of the monitored parameters when the system has a fixed pulse width with variable frequency. During the charging process, the current moves in steps through different set points (units shown on right hand axis). The voltages usually move with current changes. The graph shows the frequency changes (units shown on left hand axis) during this charging process. This graph also shows how the step currents can be manipulated to prevent the battery from getting too hot. The battery reaches a maximum temperature early in the charging process and then cools (units on left hand axis). At the beginning of the formation while the initial chemical reaction is going on, the current is maintained at a lower level. As the reaction starts to decrease the current is gradually increased, until the negative plate forms out and then the current is gradually decreased again to prevent the battery temperature from getting too high.

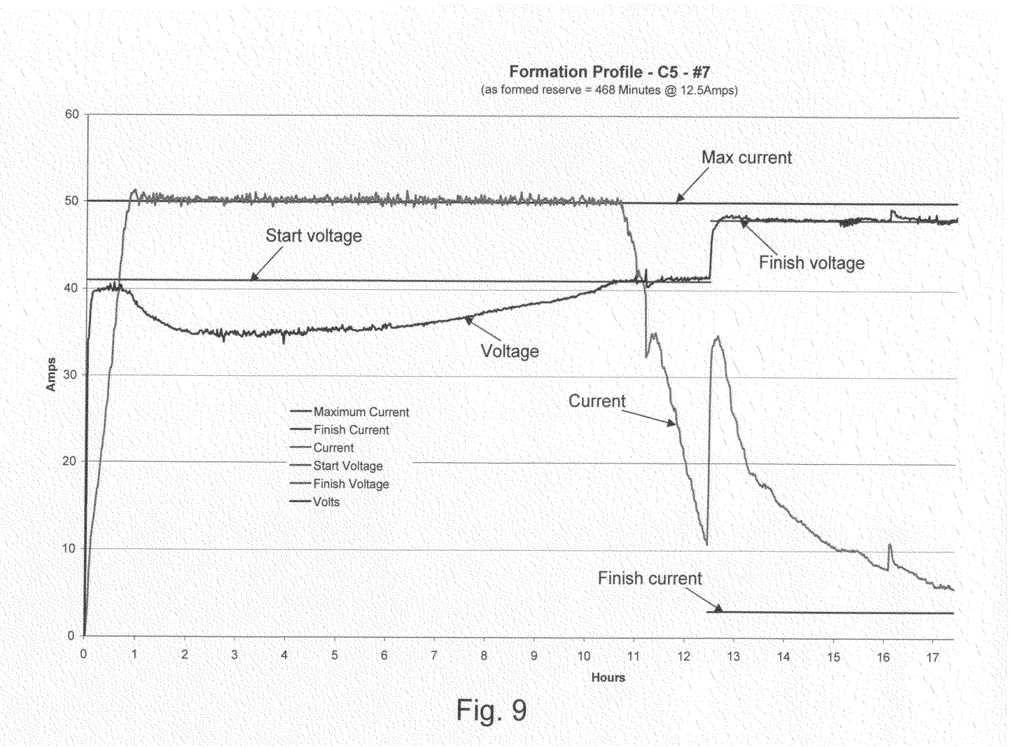

FIG. 9 shows an adaptive charging process that basically includes two float charges. A first float charge is performed during form-out of the negative plates which is at a lower voltage, a start voltage. The system float charges during that first portion, so the current increases to a max current level and the battery voltage increases to the start voltage level. When the battery voltage stabilizes at the start voltage level, the system starts decreasing the charge current until it hits a low threshold. Then the system switches to basically a second float charge which rapidly increases the current until the battery voltage reaches a higher finish voltage level which finishes the form out of the positive plates and provides the final charge state of the battery. When the battery voltage stabilizes at the finish voltage level, the system again starts decreasing the charge current until it hits a low finish current threshold.

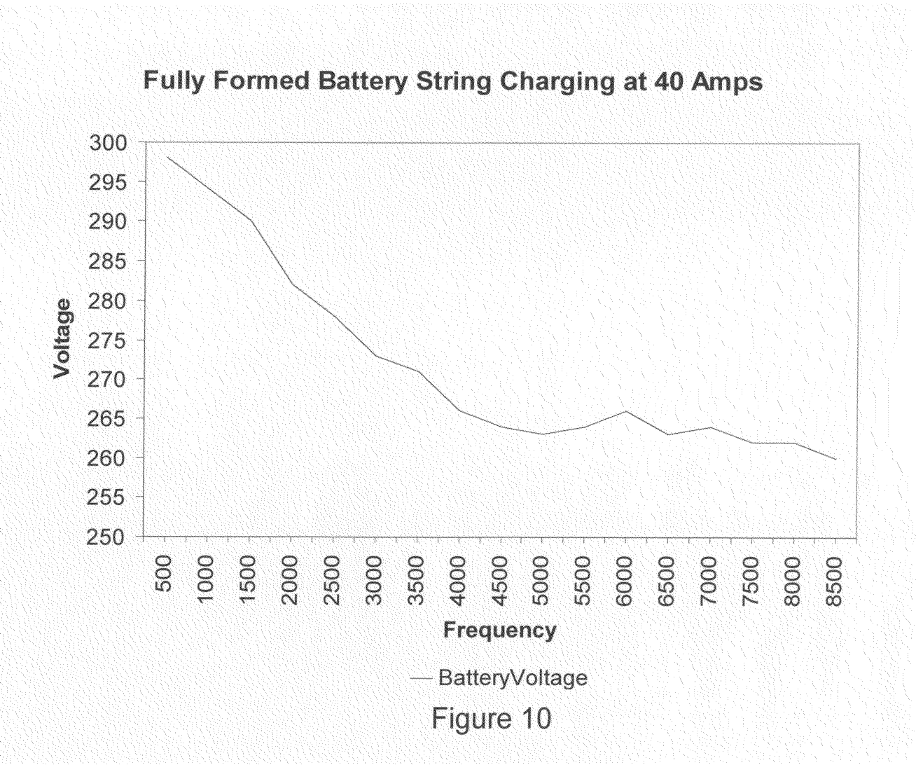

FIG. 10 shows the affect that frequency has on the efficiency at which a battery accepts a charge. As the frequency increases while the charge current remains the same, the battery voltage drops. This is due to the reduction of surface charge (plate polarity) that is being built up inside the battery. Standard DC chargers must first over come this plate polarity issue before any charge current is allowed. Therefore standard DC chargers operate at a higher voltage for a given current than the system disclosed herein. As seen in FIG. 10, the voltage to charge these batteries is significantly less at 5,000 Hz than at 500 Hz. This decreased voltage results in a significant decrease in the amount of energy (power) required to charge a battery. Additionally, DC chargers, in an effort to decrease the plate polarity effect, may have to add discharge (conditioning) steps to their charging profile to adequately reduce the plate polarity enough to finish the formation charge cycle to an acceptable state of charge. The present system, due to its lower plate polarity levels, can charge these batteries to the same state of charge level without the need for discharge (conditioning) steps. Further reducing the amount of energy needed to fully charge a given battery.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

### APPENDIX A

### Exemplary Profile Step Definitions

### Exemplary Step Type Options:

Automatic Charge to Voltage,
Automatic Complete,
Fully Automatic,
Constant Current (by Time, Step A (or W)-Hrs, or Profile A (or W)-Hrs),
Constant Current Fixed Frequency (by Time, Step A (or W)-Hrs, or Profile A (or W)-Hrs),
Rest, and
Automatic Rest.
   Each of these step type definitions are described in greater detail starting on the next page.

### Automatic Charge to Voltage Step Type

This step type charges at a specified current level until the battery string voltage reaches a specified voltage target for the step. This step does not have a time or power limit. If the target voltage is chosen incorrectly, this step will continue until a Max Program power is reached. The parameters for this step are:
Current Setpoint: This sets the charge rate in amps
Volts per Cell: This is the target voltage for each battery cell which will signal the completion of the step.
Number of Batteries: This is the number of batteries in the string being charged. This will be used as this program's default number. When this program is executed, the operator will be allowed to modify this number. This value is used to determine the total voltage setpoint for the target completion point.
Number of Cells per Batteries: This is the number of cells per battery being charged. This value is used to determine the total voltage setpoint for the target completion point.
Maximum Battery Temperature: This is the maximum allowed temperature for the batteries during this step. If the battery temperature exceeds this temperature setpoint, the charge current will be reduced to allow the batteries to cool.
Maximum Frequency: This is the maximum allowed frequency allowed during this step. To control charge current, the frequency will be varied from 77 hertz up to this maximum value to achieve the current setpoint. Usually this setpoint would be set to the maximum allowed by the hardware. Higher frequencies are usually beneficial for thicker plate batteries. As the charge frequencies increase, the potential for resonance problems also increase. Resonance is usually more of a problem for the system hardware than for the batteries themselves. When resonance occurs, the ability to charge at the selected charge rate is challenged. The system hardware may be capable of charging at the selected rate, but the hardware will be stressed during resonance charging. This hardware stress may be visible as a rise in snubber capacitor temperature, heat sink temperature, or increased frequency and/or pulse width for a given charge current. For small resonance issues, the current rate may drop slightly (10-20%) as the frequency increases without hardware temperature increases. When the resonance issue is greater (+30%), then hardware heating will become evident. This heating will shorten the life of the components in the charger system, and this heating reduces the actual A-hrs put into the batteries. Normally the reduction of energy placed into the batteries is not significant, but in extreme cases the reduction can be noticeable in the final performance of the batteries (batteries not fully formed out for a known good A-hr amount).
Pulse Width: This is the pulse width in μ-seconds. The higher this value is, the lower the frequency value will be at execution time for a given charge current. Lowering this setpoint value will allow for higher frequencies during charging.

### Automatic Complete Step Type

This step type charges at a specified current level until the battery string voltage reaches a specified target voltage. At that point, the charging rate drops to maintain the voltage level until a finish threshold value is met. This step does not have a time or power limit. If the target voltage or finish threshold values are chosen incorrectly, this step will continue until a Max Program power is reached. The parameters for this step are:
Current Setpoint: This sets the charge rate in amps
Volts per Cell: This is the target voltage for each battery cell.
Number of Batteries: This is the number of batteries in the string being charged. This will be used as this program's default number. When this program is executed, the operator will be allowed to modify this number. This value is used to determine the total voltage setpoint.
Number of Cells per Batteries: This is the number of cells per battery being charged. This value is used to determine the total voltage setpoint.
Maximum Battery Temperature: This is the maximum allowed temperature for the batteries during this step. If the battery temperature exceeds this temperature setpoint, the charge current will be reduced to allow the batteries to cool.
Maximum Frequency: This is the maximum frequency allowed during this step. To control charge current, the frequency will be varied from 77 hertz up to this maximum value to achieve the current setpoint. This setpoint is usually set to the maximum allowed by the hardware. Higher frequencies are usually beneficial for thicker plate batteries. As the charge frequencies increase, the potential for resonance problems also increase. Resonance is usually more of a problem for the system hardware than for the batteries themselves. When resonance occurs, the ability to charge at the selected charge rate is challenged. The system hardware may be capable of charging at the selected rate, but the hardware will be stressed during resonance charging. This hardware stress may be visible as a rise in snubber capacitor temperature, heat sink temperature, or increased frequency and/or pulse width for a given charge current. For small resonance issues, the current rate may drop slightly (10-20%) as the frequency increases without hardware temperature increases. When the resonance issue is greater (+30%), then hardware heating will become evident. This heating will shorten the life of the components in the charger system, and this heating reduces the actual A-hrs put into the batteries. Normally the reduction of energy placed into the batteries is not significant, but in extreme cases the reduction can be noticeable in the final performance of the batteries (batteries not fully formed out for a known good A-hr amount).
Pulse Width: This is the pulse width in μ-seconds. The higher this value is, the lower the frequency value will be at execution time for a given charge current. Lowering this setpoint value allows for higher frequencies during charging.
Threshold Type: This step can be completed by reaching either a frequency or current threshold. Different situations might make one or the other threshold type more desirable. For example, if the automatic completion step is during the negative plate form out, it is usually more desirable to use frequency as the threshold type. This may be more desirable because charging current (amps) may vary during this phase, while frequency drop is more repeatable and a better indicator of the completion point. As another example, if the automatic completion step is during final formation completion, it is usually more desirable to use current as the threshold type. This is usually more desirable because the final charging current (amps) is usually a better indicator of final battery state of charge.
Threshold Value (Frequency or Current): This value is either the frequency in Hertz or the current in Amps depending on the Threshold Type selected for this step. For negative plate form out, an exemplary frequency threshold value is approximately one-tenth of the main charge frequency. For example, if the charging frequency to initially reach the setpoint voltage is 8,500 Hz then 850 Hz may be a good starting point for the negative form out. For end of formation indication, an exemplary final current setpoint of 3 or 4 amps may be a good starting point for the formation complete threshold.

### Fully Automatic Step Type

This step type forms out the batteries using a single fully automatic step. This step does not have a time or power limit. If the target voltages or finish threshold values are chosen incorrectly, this step will continue until the Max Program power is reached.

This step includes three separate phases.

The first phase (Phase I) starts the formation by slowly ramping up the current over a period of thirty minutes before increasing the charge rate to the full current setpoint.

The second phase (Phase II) is an Automatic Completion Step. Once the Phase II battery voltage is reached, the current is reduced to maintain battery voltage until a low frequency threshold is met. The end of this phase coincides with the negative plate form out.

The third phase (Phase III) is also an Automatic Completion Step. Once the Phase III battery voltage is reached, the current is reduced to maintain battery voltage until a low current threshold is met. During this phase, the positive plates form out and the battery is charged to its final state of charge. The end of this phase coincides with the completion of the battery formation.

The parameters for this step are:
Current Setpoint: This sets the charge rate in amps
Phase II Volts per Cell: This is the target voltage for each battery cell during Phase II of this step (Negative plate form out).
Phase III Volts per Cell: This is the target voltage for each battery cell during Phase III of this step (formation completion).
Number of Batteries: This is the number of batteries in the string being charged. This will be used as this program's default number. When this program is executed, the operator will be allowed to modify this number. This value is used to determine the total voltage setpoint.
Number of Cells per Batteries: This is the number of cells per battery being charged. This value is used to determine the total voltage setpoint.
Phase II Maximum Battery Temperature: This is the maximum allowed temperature for the batteries during Phase II of this step. If the battery temperature exceeds this temperature setpoint, the charge current will be reduced to allow the batteries to cool.
Phase III Maximum Battery Temperature: This is the maximum allowed temperature for the batteries during Phase III of this step. If the battery temperature exceeds this temperature setpoint, the charge current will be reduced to allow the batteries to cool.
Maximum Frequency: This is the maximum frequency allowed during this step. To control charge current, the frequency will be varied from 77 hertz up to this maximum value to achieve the current setpoint. This setpoint is usually set to the maximum allowed by the hardware. Higher frequencies are usually beneficial for thicker plate batteries. As the charge frequencies increase, the potential for resonance problems also increase. Resonance is usually more of a problem for the system hardware than for the batteries themselves. When resonance occurs, the ability to charge at the selected charge rate is challenged. The system hardware may be capable of charging at the selected rate, but the hardware will be stressed during resonance charging. This hardware stress may be visible as a rise in snubber capacitor temperature, heat sink temperature, or increased frequency and/or pulse width for a given charge current. For small resonance issues, the current rate may drop slightly (10-20%) as the frequency increases without hardware temperature increases. When the resonance issue is greater (+30%), then hardware heating will become evident. This heating will shorten the life of the components in the charger system, and reduces the A-hrs put into the batteries. Normally the reduction of energy placed into the batteries is not significant, but in extreme cases the reduction can be noticeable in the final performance of the batteries (batteries not fully formed out for a known A-hr amount).
Pulse Width: This is the pulse width in μ-seconds. The higher this value is, the lower the frequency value will be at execution time for a given charge current. Lowering this setpoint value allows for higher frequencies during charging.
Frequency Threshold Value: This value is for Phase II completion (negative plate form out). An exemplary frequency threshold value is approximately one-tenth of the main charge frequency. For example, if the charging frequency to initially reach the setpoint voltage is 8,500 Hz, then 850 Hz may be a good starting point for the negative form out.
Current Threshold Value: This value is for Phase III completion (formation complete). An exemplary current setpoint of 3 or 4 amps may be a good starting point for the formation complete threshold.

### Constant Current Step Type

This step type charges at the specified current level until a threshold value is met. This step utilizes a fixed pulse width while varying the frequency to maintain the selected charge current rate.

The threshold for this step can be time, A-Hrs or W-Hrs for this step, or Total A-Hrs or W-Hrs for the entire profile. This last threshold type is useful after an automatic step to insure that a minimum number of A-Hrs or W-Hrs have been placed into the batteries. If the total number of A-Hrs (or W-Hrs) for the current formation already exceeds the A-hrs (or W-Hrs) value for this total threshold type then the step completes immediately.

The parameters for this step are:
Current Setpoint: This sets the charge rate in amps
Maximum Battery Temperature: This is the maximum allowed temperature for the batteries during this step. If the battery temperature exceeds this temperature setpoint, the charge current will be reduced to allow the batteries to cool.
Maximum Frequency: This is the maximum frequency allowed during this step. To control charge current, the frequency will be varied from 77 hertz up to this maximum value to achieve the current setpoint. This setpoint is usually set to the maximum allowed by the hardware. Higher frequencies are usually beneficial for thicker plate batteries. As the charge frequencies increase, the potential for resonance problems also increase. Resonance is usually more of a problem for the system hardware than for the batteries themselves. When resonance occurs, the ability to charge at the selected charge rate is challenged. The system hardware may be capable of charging at the selected rate, but the hardware will be stressed during resonance charging. This hardware stress may be visible as a rise in snubber capacitor temperature, heat sink temperature, or increased frequency and/or pulse width for a given charge current. For small resonance issues, the current rate may drop slightly (10-20%) as the frequency increases without hardware temperature increases. When the resonance issue is greater (+30%), then hardware heating will become evident. This heating can shorten the life of the components in the charger system, and reduce the actual A-hrs put into the batteries. Normally the reduction of energy placed into the batteries is not significant, but in extreme cases the reduction can be noticeable in the final performance of the batteries (batteries not fully formed out for a known good A-hr amount).
Pulse Width: This is the pulse width in μ-seconds. The larger this value is, the lower the frequency value will be at execution time for a given charge current. Lowering this setpoint value allows for higher frequencies during charging.
Threshold Type: This step can be completed by reaching a threshold of: (1) time, (2) A-Hrs for this step, (3) W-Hrs for this step, (4) total A-Hrs for the entire formation, or (5) total W-Hrs for the entire formation.
Threshold Value (Time, A-Hrs, or W-Hrs): This value is the time, A-Hrs, or W-Hrs threshold depending on the Threshold Type selected.

### Constant Current, Fixed Frequency Step Type

This step type charges at the specified current level until a threshold value is met. This step utilizes a fixed frequency while varying the pulse width to maintain the selected charge current rate.

The threshold for this step can be either time, A-Hrs or W-Hrs for this step, or Total A-Hrs or W-Hrs for the entire profile. The last threshold type is useful after an automatic step to insure that a minimum number of A-Hrs or W-Hrs have been placed into the batteries. If the total number of A-Hrs (or W-Hrs) for the current formation already exceeds the A-hrs (or W-Hrs) value for this total threshold type then the step completes immediately.

The parameters for this step are:
Current Setpoint: This sets the charge rate in amps.
Maximum Battery Temperature: This is the maximum allowed temperature for the batteries during this step. If the battery temperature exceeds this temperature setpoint, the charge current will be reduced to allow the batteries to cool.
Maximum Frequency: This is the frequency which this step will charge at. Higher frequencies are usually beneficial for thicker plate batteries and to lower the overall voltage of the battery string. As the charge frequencies increase, the potential for resonance problems also increase. Resonance is more of a problem for the system hardware than the batteries themselves. When resonance occurs, the ability to charge at the selected charge rate is challenged. The system hardware may be capable of charging at the selected rate, but the hardware will be stressed during resonance charging. This hardware stress may be visible as a rise in snubber capacitor temperature, heat sink temperature, or increased frequency and/or pulse width for a given charge current. For small resonance issues, the current rate may drop slightly (10-20%) as the frequency increases without hardware temperature increases. When the resonance issue is greater (+30%), then hardware heating will become evident. This heating can shorten the life of the components in the charger system, and reduce the actual A-hrs put into the batteries. Normally the reduction of energy placed into the batteries is not significant, but in extreme cases the reduction can be noticeable in the final performance of the batteries (batteries not fully formed out for a known good A-hr amount).
Pulse Width (Duty Cycle): For this step this is the Duty Cycle (% of on-time for each pulse). The value entered can have an “implied” decimal point (e.g. a value of 555 may actually represent a 55.5% duty cycle). The larger this value, the less time the batteries will have at maximum charging to absorb the voltage (energy) of the pulse before the next pulse starts. This value should usually stay below 600 (60.0% duty cycle).
Threshold Type: This step can be completed by reaching a threshold of: (1) time, (2) A-Hrs for this step, (3) W-Hrs for this step, (4) total A-Hrs for the entire formation, or (5) total W-Hrs for the entire formation.
Threshold Value (Time, A-Hrs, or W-Hrs): This value is the time, A-Hrs, or W-Hrs threshold depending on the Threshold Type selected.

### Rest Step Type

This step type pauses charging for a specified time period.

The parameter for this step is:
Time: This is the amount of time that this step pauses charging.

### Automatic Rest Step Type

This step type pauses charging until the battery temperature reaches a specified temperature threshold. If the temperature threshold is chosen incorrectly, this step may never complete. For example, if a temperature threshold of 40° F. is selected in a hot environment (over 70° F.), this step will never complete since the battery temperature will never reach the temperature threshold.

If the battery temperature is already below the specified temperature threshold when this step is started, then the step will complete immediately.

This step may be useful when there is a process requirement of having a lower maximum battery temperature after negative plate form out than before. In this case, the batteries during negative form out are allowed to charge at a higher temperature, but once the string voltage increases (signifying negative plate form out) then it is preferred to maintain a lower maximum battery temperature. The use of an Automatic Completion step to recognize the negative plate form out, followed by this step would allow for an efficient rest step that only pauses as long as necessary to lower the battery temperature down to an acceptable level.

The parameter for this step is:
Temperature: This is the temperature threshold that the battery must get below for this step to complete.

### APPENDIX B

Exemplary Profile

| | \ global parameters |
|---|---|
| 1100 | \ MAXIMUM PROFILE Power |
| 130 | \ MAXIMUM SNUBBER CAPACITOR TEMP |
| | \ PROFILE STEP #1 PARMETERS |
| 5 | \ CONSTANT CURRENT STEP |
| 10 | \ CURRENT SETPT |
| 170 | \ MAX BATTERY TEMP |
| 7000 | \ MAX HERTZ |
| 40 | \ PULSE WIDTH |
| 5 | \ DURATION IN MINUTES, A-HR, or W-HR |
| 2 | \ DURATION TYPE=1 FOR MINUTES, 2 FIXED A-HR, 3 TOTAL A-HR, 4 |
| | FIXED W-HR, 5 TOTAL W-HR |
| | \ PROFILE STEP #2 PARMETERS |
| 5 | \ CONSTANT CURRENT STEP |
| 15 | \ CURRENT SETPT |
| 170 | \ MAX BATTERY TEMP |
| 7000 | \ MAX HERTZ |
| 45 | \ PULSE WIDTH |
| 5 | \ DURATION IN MINUTES, A-HR, or W-HR |
| 2 | \ DURATION TYPE=1 FOR MINUTES, 2 FIXED A-HR, 3 TOTAL A-HR, 4 |
| | FIXED W-HR, 5 TOTAL W-HR |
| | \ PROFILE STEP #3 PARMETERS |
| 5 | \ CONSTANT CURRENT STEP |
| 20 | \ CURRENT SETPT |
| 170 | \ MAX BATTERY TEMP |
| 7000 | \ MAX HERTZ |
| 50 | \ PULSE WIDTH |
| 50 | \ DURATION IN MINUTES, A-HR, or W-HR |
| 2 | \ DURATION TYPE=1 FOR MINUTES, 2 FIXED A-HR, 3 TOTAL A-HR, 4 |
| | FIXED W-HR, 5 TOTAL W-HR |
| | \ PROFILE STEP #4 PARMETERS |
| 5 | \ CONSTANT CURRENT STEP |
| 30 | \ CURRENT SETPT |
| 170 | \ MAX BATTERY TEMP |
| 7000 | \ MAX HERTZ |
| 80 | \ PULSE WIDTH |
| 50 | \ DURATION IN MINUTES, A-HR, or W-HR |
| 2 | \ DURATION TYPE=1 FOR MINUTES, 2 FIXED A-HR, 3 TOTAL A-HR, 4 |
| | FIXED W-HR, 5 TOTAL W-HR |
| | \ PROFILE STEP #5 PARMETERS |
| 5 | \ CONSTANT CURRENT STEP |
| 35 | \ CURRENT SETPT |
| 170 | \ MAX BATTERY TEMP |
| 7000 | \ MAX HERTZ |
| 85 | \ PULSE WIDTH |
| 100 | \ DURATION IN MINUTES, A-HR, or W-HR |
| 2 | \ DURATION TYPE=1 FOR MINUTES, 2 FIXED A-HR, 3 TOTAL A-HR, 4 |
| | FIXED W-HR, 5 TOTAL W-HR |
| | \ PROFILE STEP #6 PARMETERS |
| 5 | \ CONSTANT CURRENT STEP |
| 40 | \ CURRENT SETPT |
| 170 | \ MAX BATTERY TEMP |
| 7000 | \ MAX HERTZ |
| 85 | \ PULSE WIDTH |
| 125 | \ DURATION IN MINUTES, A-HR, or W-HR |
| 2 | \ DURATION TYPE=1 FOR MINUTES, 2 FIXED A-HR, 3 TOTAL A-HR, 4 |
| | FIXED W-HR, 5 TOTAL W-HR |
| | \ PROFILE STEP #7 PARMETERS |
| 5 | \ CONSTANT CURRENT STEP |
| 35 | \ CURRENT SETPT |
| 170 | \ MAX BATTERY TEMP |
| 7000 | \ MAX HERTZ |
| 80 | \ PULSE WIDTH |
| 120 | \ DURATION IN MINUTES, A-HR, or W-HR |
| 2 | \ DURATION TYPE=1 FOR MINUTES, 2 FIXED A-HR, 3 TOTAL A-HR, 4 |
| | FIXED W-HR, 5 TOTAL W-HR |
| | \ PROFILE STEP #8 PARMETERS |
| 5 | \ CONSTANT CURRENT STEP |
| 30 | \ CURRENT SETPT |
| 170 | \ MAX BATTERY TEMP |
| 7000 | \ MAX HERTZ |
| 80 | \ PULSE WIDTH |
| 160 | \ DURATION IN MINUTES, A-HR, or W-HR |
| 2 | \ DURATION TYPE=1 FOR MINUTES, 2 FIXED A-HR, 3 TOTAL A-HR, 4 |
| | FIXED W-HR, 5 TOTAL W-HR |
| | \ PROFILE STEP #9 PARMETERS |
| 5 | \ CONSTANT CURRENT STEP |
| 25 | \ CURRENT SETPT |
| 160 | \ MAX BATTERY TEMP |
| 7000 | \ MAX HERTZ |
| 70 | \ PULSE WIDTH |
| 75 | \ DURATION IN MINUTES, A-HR, or W-HR |
| 2 | \ DURATION TYPE=1 FOR MINUTES, 2 FIXED A-HR, 3 TOTAL A-HR, 4 |
| | FIXED W-HR, 5 TOTAL W-HR |
| | \ PROFILE STEP #10 PARMETERS |
| 5 | \ CONSTANT CURRENT STEP |
| 10 | \ CURRENT SETPT |
| 160 | \ MAX BATTERY TEMP |
| 7000 | \ MAX HERTZ |
| 50 | \ PULSE WIDTH |
| 10 | \ DURATION IN MINUTES, A-HR, or W-HR |
| 2 | \ DURATION TYPE=1 FOR MINUTES, 2 FIXED A-HR, 3 TOTAL A-HR, 4 |
| | FIXED W-HR, 5 TOTAL W-HR |
| | \ PROFILE STEP #11 PARMETERS |
| 0 | \ SET UNUSED STEPS TO ZERO TO SIGNAL END OF PROFILE |
| | \ PROFILE STEP #12 PARMETERS |
| 0 | \ SET UNUSED STEPS TO ZERO TO SIGNAL END OF PROFILE |
| | \ PROFILE STEP #13 PARMETERS |
| 0 | \ SET UNUSED STEPS TO ZERO TO SIGNAL END OF PROFILE |
| | \ PROFILE STEP #14 PARMETERS |
| 0 | \ SET UNUSED STEPS TO ZERO TO SIGNAL END OF PROFILE |
| | \ PROFILE STEP #15 PARMETERS |
| 0 | \ SET UNUSED STEPS TO ZERO TO SIGNAL END OF PROFILE |
| | \ PROFILE STEP #16 PARMETERS |
| 0 | \ SET UNUSED STEPS TO ZERO TO SIGNAL END OF PROFILE |
| | \ PROFILE STEP #17 PARMETERS |
| 0 | \ SET UNUSED STEPS TO ZERO TO SIGNAL END OF PROFILE |
| | \ PROFILE STEP #18 PARMETERS |
| 0 | \ SET UNUSED STEPS TO ZERO TO SIGNAL END OF PROFILE |
| | \ PROFILE STEP #19 PARMETERS |
| 0 | \ SET UNUSED STEPS TO ZERO TO SIGNAL END OF PROFILE |
| | \ PROFILE STEP #20 PARMETERS |
| 0 | \ SET UNUSED STEPS TO ZERO TO SIGNAL END OF PROFILE |

We claim:

1. A battery formation and charging process for charging a battery using a battery charging system, the process comprising:
applying a charging current pulse to the battery at a repetition rate, the charging current pulse having a current value and a pulse width of less than 10 milliseconds;
monitoring a battery temperature of the battery;
determining whether to change at least one of the current value, the repetition rate or the pulse width of the charging current pulse; and
changing at least one of the current value, the repetition rate or the pulse width of the charging current pulse, if it is determined that a change is desired.

2. The battery formation and charging process of claim 1, further comprising:
decreasing the current value of the charging current pulse if the battery temperature exceeds a battery temperature threshold.

3. The battery formation and charging process of claim 1, wherein the battery includes a battery post and the step of monitoring a battery temperature comprises:
coupling a temperature sensor to the battery post; and
monitoring a battery post temperature using the temperature sensor.

4. The battery formation and charging process of claim 1, further comprising:
monitoring a hardware temperature of the battery charging system; and
decreasing the repetition rate of the charging current pulse if the hardware temperature exceeds a hardware temperature threshold.

5. The battery formation and charging process of claim 1, wherein the current value of the charging current pulse is approximately in the range of 5 to 50 times of a total amp-hour capacity of the battery.

6. The battery formation and charging process of claim 1, wherein the pulse width of the charging current pulse is approximately in the range of 1 μsec to 7 msec.

7. The battery formation and charging process of claim 1, wherein the repetition rate of the charging current pulse is approximately in the range of 80 Hertz to 20,000 Hertz.

8. The battery formation and charging process of claim 1, further comprising:
monitoring a battery voltage across the battery;
monitoring a battery current being applied to the battery by the charging current pulse;
calculating a battery resistance using the battery voltage and the battery current; and
using the battery resistance in the step of determining whether to change at least one of the current value, the repetition rate or the pulse width of the charging current pulse.

9. The battery formation and charging process of claim 1, further comprising selecting the repetition rate for the charging current pulse by:
sweeping the repetition rate of the charging current pulse across a frequency range;
tracking a current transferred to the battery for the frequencies in the frequency range; and
making the repetition rate of the charging current pulse have the frequency in the frequency range at which the maximum current is transferred to the battery.

10. The battery formation and charging process of claim 9, wherein the step of selecting the repetition rate is performed periodically during the battery formation and charging process.

11. The battery formation and charging process of claim 1, further comprising:
determining whether the battery charging system is in resonance; and
switching the repetition rate of the charging current pulse if the battery charging system is in resonance.

12. The battery formation and charging process of claim 11, wherein the step of switching the repetition rate of the charging current pulse if the battery charging system is in resonance comprises:
sweeping the repetition rate of the charging current pulse across a frequency range;
tracking a current transferred to the battery for the frequencies in the frequency range; and
switching the repetition rate of the charging current pulse to the frequency in the frequency range at which the maximum current is transferred to the battery.

13. The battery formation and charging process of claim 1, wherein the battery formation and charging process comprises a series of separate steps, each of the separate steps comprising:
defining the current value of the charging current pulse;
defining a maximum repetition rate for the charging current pulse, the repetition rate of the charging current pulse being less than the maximum repetition rate;
defining the pulse width of the charging current pulse;
defining a maximum battery temperature for the battery;
maintaining the battery temperature below the maximum battery temperature; and
defining a completion criteria for the step, the step ending when the completion criteria is reached.

14. The battery formation and charging process of claim 13, wherein a timed step of the series of separate steps further comprises:
tracking an elapsed time for the timed step;
wherein the completion criteria is a total step time, the timed step ending when the elapsed time reaches the total step time.

15. The battery formation and charging process of claim 13, wherein a current threshold step of the series of separate steps further comprises:
tracking an elapsed time for the current threshold step;
tracking an applied amp-hours, the applied amp-hours being equal to the amp-hours applied to the battery by the battery charging system;
wherein the completion criteria is an amp-hours threshold, the current threshold step ending when the applied amp-hours reaches the amp-hours threshold.

16. The battery formation and charging process of claim 13, wherein a power threshold step of the series of separate steps further comprises:
tracking an elapsed time for the power threshold step;
tracking an applied watt-hours, the applied watt-hours being equal to the watt-hours applied to the battery by the battery charging system;
wherein the completion criteria is a watt-hours threshold, the power threshold step ending when the applied watt-hours reaches the watt-hours threshold.

17. A battery formation and charging system for forming or charging a battery using a power supply, the battery formation and charging system comprising:
a control processor;
an input switch having an input and an output, the input switch being controlled by the control processor, the input of the input switch being coupled to the power supply, the control processor controlling the input switch to accept or not accept power from the power supply;
a filter network having an input and an output, the input of the filter network being coupled to the output of the input switch;
a charging switch having an input and an output, the charging switch being controlled by the control processor, the input of the charging switch being coupled to the output of the filter network, the output of the charging switch being coupled to the battery, the control processor controlling the charging switch to control the current delivered to the battery;
a battery temperature sensor monitoring a temperature of the battery, readings from the battery temperature sensor being monitored by the control processor;
an input voltage sensor monitoring a voltage applied by the input switch across the filter network, readings from the input voltage sensor being monitored by the control processor;
a charging voltage sensor monitoring a voltage applied by the charging switch across the battery, readings from the charging voltage sensor being monitored by the control processor;
a charging current sensor monitoring a current controlled by the charging switch and applied to the battery, readings from the charging current sensor being monitored by the control processor;
wherein the control processor uses the readings from the battery temperature sensor, the input voltage sensor, the charging voltage sensor and the charging current sensor to control the input switch and the charging switch to deliver a charging waveform to the battery, the charging waveform being selected to perform an efficient charging of the battery.

18. The battery formation and charging system of claim 17, wherein the charging switch is an insulated gate bipolar transistor device.

19. The battery formation and charging system of claim 17, wherein the battery includes a battery post and the battery temperature sensor monitors the temperature of the battery post.

20. The battery formation and charging system of claim 17, wherein the charging waveform has a peak value, a pulse width and a frequency; and the control processor decreases the peak value of the charging waveform when the control processor determines that the readings from the battery temperature sensor exceed a maximum allowable battery temperature.

21. The battery formation and charging system of claim 17, further comprising:
a hardware temperature sensor monitoring a temperature of the battery formation and charging system, readings from the hardware temperature sensor being monitored by the control processor;
wherein the charging waveform has a peak value, a pulse width and a frequency; the control processor uses the readings from the hardware temperature sensor to determine whether the battery formation and charging system is in resonance; and the control processor changes the frequency of the charging waveform when the control processor determines that the battery formation and charging system is in resonance.

22. The battery formation and charging system of claim 17, wherein the control processor controls the charging waveform to have one of a fixed pulse width and a varying frequency or a varying pulse width and a fixed frequency; and the control processor controls the varying component to control the current delivered to the battery.

23. The battery formation and charging system of claim 17, wherein the charging waveform has a frequency; the control processor periodically sweeps through a range of frequencies to select a desired frequency for the charging waveform; and the control processor updates the frequency of the charging waveform based on the desired frequency.

24. The battery formation and charging system of claim 17, wherein the filter network comprises:
a first capacitor bank to reduce electrical noise in the power delivered by the output switch; the first capacitor bank comprising a plurality of capacitors; and
a second capacitor bank to suppress high frequency components in the power delivered by the output switch; the capacitance values of capacitors in the second capacitor bank being less than the capacitance values of capacitors in the first capacitor bank; and
a resistor to bleed off voltage from the first and second capacitor banks when power is removed by the input switch.

25. The battery formation and charging system of claim 17, wherein the charging switch comprises:
an insulated gate bipolar transistor;
a snubber capacitor bank to suppress high frequency components of current reflections from the battery;
a resistor to bleed off voltage from the snubber capacitor bank when power is removed; and
a hardware temperature sensor monitoring a temperature of the snubber capacitor bank, readings from the hardware temperature sensor being monitored by the control processor;
wherein the control processor uses the readings from the hardware temperature sensor to determine whether the battery formation and charging system is in resonance; and the control processor changes a frequency of the charging waveform when the control processor determines that the battery formation and charging system is in resonance.

26. The battery formation and charging system of claim 17, further comprising an external monitor, the control processor providing status and data to the external monitor.

27. The battery formation and charging system of claim 26, wherein the control processor accepts commands from the external monitor.
